(19) United States
(12) Patent Application Publication
(10) Pub. No.: US 2025/0126547 A1
(43) Pub. Date: Apr. 17, 2025

(54) ASSISTED ACCESS TO A SERVING CELL FOR WIRELESS COMMUNICATIONS

(71) Applicant: QUALCOMM Incorporated, San Diego, CA (US)

(72) Inventors: Aria HASANZADEZONUZY, Somerville, NJ (US); Kianoush HOSSEINI, San Diego, CA (US); Umesh PHUYAL, San Diego, CA (US); Tao LUO, San Diego, CA (US); Aleksandar DAMNJANOVIC, Del Mar, CA (US)

(21) Appl. No.: 18/487,748

(22) Filed: Oct. 16, 2023

(51) Int. Cl. H04W 48/10; H04W 48/16; H04W 74/08

(52) U.S. Cl. CPC H04W 48/10; H04W 48/16; H04W 74/0833

(57) ABSTRACT

Methods, systems, and devices for wireless communications are described. Techniques described herein provide assisted access to a serving cell for wireless communications. A UE may receive a broadcast system information message from the first cell. The broadcast system information message may include system information usable for communicating with the second cell. Using the received system information, the UE may transmit, to the first cell, a random access channel (RACH) preamble message in order to establish a connection with the second cell. The first cell may transmit, to the second cell in response to receiving the RACH preamble message, a wake-up signal.

### FIELD OF TECHNOLOGY

The following relates to wireless communications, including techniques for assisted access to a serving cell for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for assisted access to a serving cell for wireless communications. For example, the described techniques provide for a first cell to assist a UE accessing a second cell that may be in a deep level of sleep for power savings. The first cell may exchange signaling with the UE for the UE to access the second cell. The first cell may transmit signaling to the second cell to wake-up the target cell for UE access to the second cell. For example, a UE may receive a broadcast system information message from the first cell. The broadcast system information message may include system information usable for communicating with the second cell. Using the received system information, the UE may transmit, to the first cell, a random access channel (RACH) preamble message in order to establish a connection with the second cell. The first cell may transmit, to the second cell in response to receiving the RACH preamble message, a wake-up signal and the RACH preamble message. Additional signaling may be exchanged between the UE and the first cell and additional signaling may be exchanged between the UE and the second cell to grant the UE access to the second cell.

### BRIEF DESCRIPTION OF THE DRAWINGS

FIG. 1 shows an example of a wireless communications system that supports techniques for assisted access to a serving cell for wireless communications in accordance with one or more aspects of the present disclosure.

FIG. 2 shows an example of a wireless communications system that supports techniques for assisted access to a serving cell for wireless communications in accordance with one or more aspects of the present disclosure.

FIG. 3 shows an example of a process flow that supports techniques for assisted access to a serving cell for wireless communications in accordance with one or more aspects of the present disclosure.

FIGS. 4 and 5 show block diagrams of devices that support techniques for assisted access to a serving cell for wireless communications in accordance with one or more aspects of the present disclosure.

FIG. 6 shows a block diagram of a communications manager that supports techniques for assisted access to a serving cell for wireless communications in accordance with one or more aspects of the present disclosure.

FIG. 7 shows a diagram of a system including a device that supports techniques for assisted access to a serving cell for wireless communications in accordance with one or more aspects of the present disclosure.

FIGS. 8 and 9 show block diagrams of devices that support techniques for assisted access to a serving cell for wireless communications in accordance with one or more aspects of the present disclosure.

FIG. 10 shows a block diagram of a communications manager that supports techniques for assisted access to a serving cell for wireless communications in accordance with one or more aspects of the present disclosure.

FIG. 11 shows a diagram of a system including a device that supports techniques for assisted access to a serving cell for wireless communications in accordance with one or more aspects of the present disclosure.

FIGS. 12 through 15 show flowcharts illustrating methods that support techniques for assisted access to a serving cell for wireless communications in accordance with one or more aspects of the present disclosure.

### DETAILED DESCRIPTION

As future generations of radio access technologies (RATs) are developed and deployed, many wireless networks will support multiple RATs during a “migration period.” For example, wireless networks will support both 5G and 6G devices as wireless devices are gradually “migrated” to 6G devices. However, there are several challenges when handling migrations across RATs. First, power consumption and network energy savings issues may arise when supporting multiple RATs within a network. For example, there may be cases where a 6G cell does not include any 6G devices. When the 6G cell is not serving a user equipment (UE), the 6G cell may be placed in a deep level of sleep for power savings.

Techniques for assisted access to a serving cell may provide power savings. For example, a first cell (e.g., 5G cell) may assist a UE accessing a second cell (e.g., 6G cell) that may be in deep level of sleep for power savings. The first cell (e.g., 5G cell) may exchange signaling with the UE for the UE to access the second cell (6G cell). The first cell (e.g., 5G cell) may transmit signaling to the second cell (e.g., 6G cell) to “wake-up” the target cell (e.g., 6G cell) for UE access to the second cell (e.g., 6G cell). For example, a UE may receive a broadcast system information message from the first cell, such as a 5G cell. The broadcast system information message may include system information usable for communicating with the second cell, such as a 6G cell. Using the received system information, the UE may transmit, to the first cell, a random access channel (RACH) preamble message in order to establish a connection with the second cell.

In some examples, the first cell may transmit, to the second cell in response to receiving the RACH preamble message, a wake-up signal and the RACH preamble message. In some cases, the first cell may decide not to wake up the second cell. The UE may receive, based on transmitting the RACH preamble message, a random access response message that indicates an uplink resource. In some cases, the random access response message may be transmitted by the first cell or the second cell. The UE may transmit, in response to receiving the random access response message, an uplink message on the uplink resource, and the uplink resource may be an uplink resource of the first cell or an uplink resource of the second cell. The UE may receive, based on transmitting the uplink message, a downlink message on a downlink resource, and the downlink resource may be a downlink resource of the first cell or a downlink resource of the second cell. Subsequent to receiving the downlink message, the UE and the second cell may begin communicating with one another if access to the second cell has been granted.

Aspects of the disclosure are initially described in the context of wireless communications systems. Aspects of the disclosure are also described in context of a timing diagram and a process flow. Aspects of the disclosure are further illustrated by and described with reference to apparatus diagrams, system diagrams, and flowcharts that relate to techniques for assisted access to a serving cell for wireless communications.

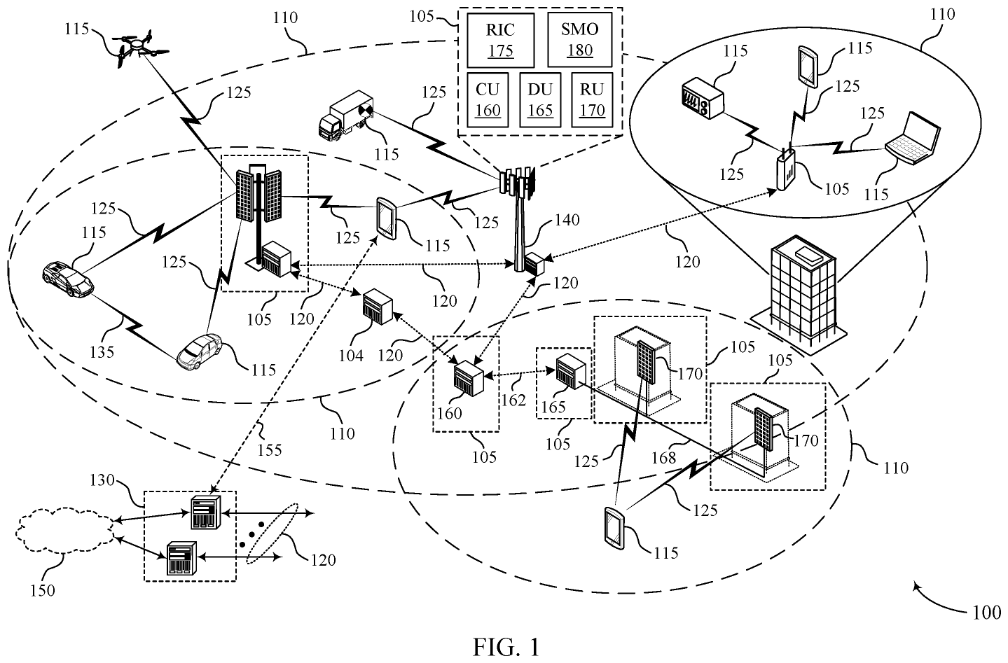

FIG. 1 shows an example of a wireless communications system 100 that supports techniques for assisted access to a serving cell for wireless communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for assisted access to a serving cell for wireless communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

As future generations of RATs are developed and deployed, many wireless networks will support multiple RATs during a “migration period.” For example, wireless networks will support both 5G and 6G devices as wireless devices are gradually migrated to 6G devices. However, there are several challenges when handling migrations across RATs. First, power consumption and network energy savings issues may arise when supporting multiple RATs within a network. For example, there may be cases where a 6G cell does not include any 6G devices. When the 6G cell is not serving a UE 115, the 6G cell may be placed in a deep level of sleep for power savings.

Techniques for assisted access to a serving cell may provide power savings. For example, a first cell (e.g., 5G cell) may assist a UE 115 accessing a second cell (e.g., 6G cell) that may be in deep level of sleep for power savings. The first cell (e.g., 5G cell) may exchange signaling with the UE 115 for the UE 115 to access the second cell (6G cell). The first cell (e.g., 5G cell) may transmit signaling to the second cell (e.g., 6G cell) to wake-up the target cell (e.g., 6G cell) for UE 115 access to the second cell (e.g., 6G cell). For example, a UE 115 may receive a broadcast system information message from the first cell, such as a 5G cell. The broadcast system information message may include system information usable for communicating with the second cell, such as a 6G cell. Using the received system information, the UE 115 may transmit, to the first cell, a RACH preamble message in order to establish a connection with the second cell.

In some examples, the first cell may transmit, to the second cell in response to receiving the RACH preamble message, a wake-up signal and the RACH preamble message. In some cases, the first cell may decide not to wake up the second cell. The UE 115 may receive, based on transmitting the RACH preamble message, a random access response message that indicates an uplink resource. In some cases, the random access response message may be transmitted by the first cell or the second cell. The UE 115 may transmit, in response to receiving the random access response message, an uplink message on the uplink resource, and the uplink resource may be an uplink resource of the first cell or an uplink resource of the second cell. The UE 115 may receive, based on transmitting the uplink message, a downlink message on a downlink resource, and the downlink resource may be a downlink resource of the first cell or a downlink resource of the second cell. Subsequent to receiving the downlink message, the UE 115 and the second cell may begin communicating with one another if access to the second cell has been granted.

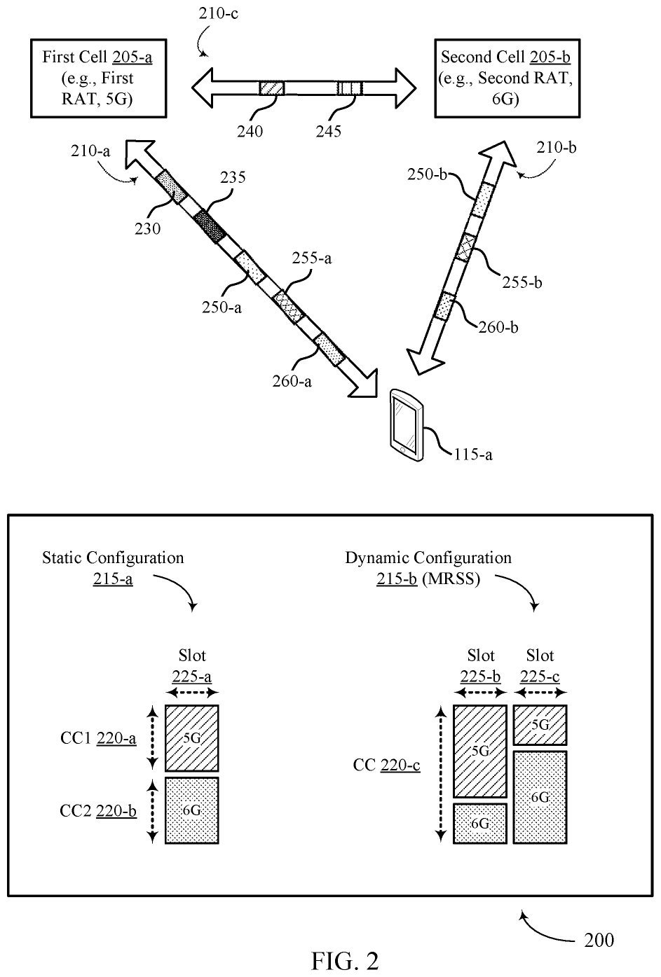

FIG. 2 shows an example of a wireless communications system 200 that supports techniques for assisted access to a serving cell for wireless communications in accordance with one or more aspects of the present disclosure. Aspects of the wireless communications system 200 may implement, or be implemented by, aspects of the wireless communications system 100. For example, the wireless communications system 200 may support signaling and configurations assisted access to a serving cell.

The wireless communications system 200 may include a UE 115-a, a first cell 205-a (e.g., source cell), and a second cell 205-b (e.g., target cell), which may be examples of UEs 115, network entities 105, and other wireless devices as described with reference to FIG. 1. In some cases, the serving cells 205 may be associated with (e.g., supported by) one or more network entities 105. For example, in some cases, the first cell 205-a and the second cell 205-b may be associated with (e.g., supported by) the same network entity 105. By way of another example, in other cases, the first cell 205-a may be associated with a first network entity 105, and the second cell 205-b may be associated with a second network entity 105.

The first cells 205-a and the second cell 205-b may be associated with the same or different radio access technologies RATs (e.g., 3G, 4G, LTE, 5G, NR, 6G, etc.), and may be configured to communicate within the same or different frequency bands. For example, in some cases, as shown in FIG. 2, the first cell 205-a may be associated with a 5G or NR RAT, and the second cell 205-b may be associated with a 6G RAT.

In some aspects, the UE 115-a may communicate with the serving cells 205 via communication links 210-a, 210-b. In some cases, the communication links 210-a, 210-b may include examples of access links (e.g., Uu links). The communication links 210-a, 210-b may include bi-directional links that can include both uplink and downlink communication. For example, the UE 115-a may transmit uplink transmissions, such as uplink control signals or uplink data signals, to the first cell 205-a using the communication link 210-a, and the first cell 205-a may transmit downlink transmissions, such as downlink control signals or downlink data signals, to the UE 115-a using the communication link 210-a. For example, the UE 115-a may transmit uplink transmissions, such as uplink control signals or uplink data signals, to the second cell 205-b using the communication link 210-b, and the second cell 205-b may transmit downlink transmissions, such as downlink control signals or downlink data signals, to the UE 115-a using the communication link 210-b.

In some examples, the first cell 205-a may communicate with the second cell 205-b via a communication link 210-c. In some cases, the communication link 210-c may include an example of an access link (e.g., Uu links), a backhaul communication link, a midhaul communication link, or a fronthaul communication link, or any combination thereof. The communication link 210-c may include bi-directional links. For example, the first cell 205-a may transmit transmissions, such as control signals or data signals, to the second cell 205-b using the communication link 210-c, and the second cell 205-b may transmit transmissions, such as control signals or data signals, to the first cell 205-a using the communication link 210-c.

In this regard, the wireless communications system 200 may be configured to support multiple RATs, including current and future RATs. As future generations of RATs are developed and deployed, the wireless communications system 200 may undergo a “migration period” during which both old (e.g., “legacy”) and new RATs are supported. For example, in the context of 5G and 6G communications, the wireless communications system 200 may support both 5G and 6G devices as wireless devices are gradually “migrated” to 6G devices.

There are several different “migration schemes” that may be used for migrating between/across RATs. For example, FIG. 2 illustrates a static configuration 215-a and a dynamic configuration 215-b that may be implemented during the migration process of the wireless communications system 200. The configurations 215 illustrate two different implementations where different RATs (e.g., 5G and 6G) can coexist within the wireless communication system 200.

The static configuration 215-a illustrates a “static reframing” configuration in which resources are divided up statically across the supported RATs in the time and/or frequency domain. With static reframing (as illustrated via the static configuration 215-a), a network vendor may dedicate a whole component carrier (or other set of resources) to 6G communications, where there is no coexistence of multiple RATs within/across the resources. For instance, as shown in the static configuration 215-a, resources within a first component carrier 220-a (CC1) (and within a given slot 225-a) may be allocated to 5G communications, whereas resources within a second component carrier 220-b (CC2) may be allocated to 6G communications. The static configuration 215-a may be constant across slots 225 or sets of slots 225, or may change from slot to slot.

Comparatively, the dynamic configuration 215-b illustrates an example of dynamic multi-RAT spectrum sharing (MRSS). With dynamic MRSS, component carriers 220 may be dynamically shared between multiple RATs (e.g., 5G and 6G) in the time, frequency, and/or spatial domains. For instance, as shown in the dynamic configuration 215-b, resources within a component carrier 220-c may be divided up and allocated for both 5G and 6G communications. Moreover, the division/allocation of resources across RATs may change from slot to slot. For example, the component carrier 220-c may be divided up according to a first allocation scheme during a first slot 225-b, and may be divided up according to a second allocation scheme during a second slot 225-c.

There are advantages and disadvantages to both the static reframing (e.g., static configuration 215-a) and the dynamic MRSS (e.g., dynamic configuration 215-b) implementations. In particular, static refarming could help with boosting network power efficiency, thereby incentivizing operators to migrate to a new RAT. Comparatively, MRSS is expected to bring resource utilization benefit, with a power-aware design for future RATs (e.g., 6G).

In some cases, wireless communications systems (such as the wireless communications system 200) may follow different migration scenarios or migration paths that utilize combinations of the static reframing (e.g., static configuration 215-a) and the dynamic MRSS (e.g., dynamic configuration 215-b) implementations. For example, some wireless communications systems may utilize only the static configuration 215-a. In such cases, the network (e.g., network vendor) may reframe some serving cells 205 of the network to provide only 6G service. As such, the network may be made up of 5G-only cells and 6G-only cells.

In other cases, a network may include 5G-only cells, as well as 5G/6G MRSS cells. In other words, the network may implement a combination of the static configuration 215-a and the dynamic configuration 215-b to include some serving cells 205 that support only 5G communications, and some cells that support both 5G and 6G communications (e.g., MRSS cells). In other words, some of the cells 205 of a cell site may remain operating in 5G, while other cells would be shared with 6G RAT dynamically. In practice, it is unlikely that MRSS is enabled everywhere within a network at the same time. As such, since the process is gradual, the use of both the static configuration 215-a and the dynamic configuration 215-b for the migration process may allow for some cells 205 within the network to remain 5G cells for a longer duration.

Similarly, in other cases, a network may include 6G-only cells, as well as 5G/6G MRSS cells. In other words, the network may implement a combination of the static configuration 215-a and the dynamic configuration 215-b to include some serving cells 205 that support only 6G communications, and some cells that support both 5G and 6G communications (e.g., MRSS cells). In other words, under this implementation, some cells 205 may be reframed for 6G-only service, while other cells 205 would be shared between 5G and 6G RATs dynamically. As more devices within the network become 6G-capable, some of the MRSS cells 205 may be phased-out of 5G and converted to 6G-only cells (e.g., sunset 5G communications/cells as more devices become 6G-capable).

Lastly, in other implementations, a network may include all 5G/6G MRSS cells 205. That is, the network may designate all serving cells 205 in the network as dynamic MRCC cells that support both 5G and 5G communications. Over time, more and more cells 205 may support MRSS assuming that both 5G and 6G have comparable market penetration.

However, there are several challenges when handling migrations across RATs. First, power consumption and network energy savings issues may arise when supporting multiple RATs within a network. For example, there may be cases where a second cell 205-b does not actually include any 6G devices. When the second cell 205-b is not serving UEs, the second cell 205-b may be placed in a deep level of sleep for power savings. For example, the second cell 205-b may be idle and not transmitting broadcast common (BC) signals. The second cell 205-b may save energy by transmitting the BC signals when serving UEs instead of transmitting the BC signals periodically. In some cases, the first cell 205-a may be active and transmitting BC signals. When the second cell 205-b is idle, a second RAT capable UE (e.g., a 6G capable UE) may request to access the second cell 205-b. Since the second cell 205-b is in the power saving mode, the second cell 205-b may not be available to perform the initial access procedure or RACH procedure directly with the UE 115-a. In some cases, the first cell 205-a may assist the UE 115-a to access the second cell 205-b. In some examples, the first cell 205-a may exchange signaling with the UE 115-a, and the first cell 205-a may transmit signaling to the second cell 205-b to wake-up the second cell 205-b. In some examples, the first cell 205-a may decide whether the UE 115-a may access the second cell 205-b for load balancing purposes.

In some examples, when the second cell 205-b is idle and the UE 115-a wants to request access to the second cell 205-b, the first cell 205-a may decide to wake-up the second cell 205-b. When the second cell 205-b is idle, the second cell 205-b may not transmit broadcast system information. The first cell 205-a may transmit a broadcast system information message 230, and the UE 115-a may receive the broadcast system information message 230 transmitted by the first cell 205-a. In some cases, the broadcast system information message 230 transmitted by the first cell 205-a may include system information for connecting to the first cell 205-a and system information for connecting to the second cell 205-b.

For example, the broadcast system information message 230 may include a synchronization signal block (SSB) message, a system information block (SIB) message, or any combination thereof. The SSB and the SIB may be SSB and SIB for connecting to the first cell 205-a with additional information for connecting to the second cell 205-b. In some examples, the SSB and SIB of the first cell 205-a (e.g., 5G) may be extended to convey additional information for connecting to the second cell 205-b (e.g., 6G) or new SSBs or new SIBs with information for connecting to the second cell 205-b may be added to the broadcast system information message 230. If the SIBs for 5G are extended to convey additional information in new fields for 6G, the new fields may be ignored by 5G capable UEs. If new SIBs for 6G are included in the broadcast system information message 230, the new SIBs for 6G may not be read by the 5G capable UEs.

In some cases, the additional information added to the SIBs of the first cell 205-a or the new SIBs may include system information (e.g., 6G system information) for RACH configuration to the second cell 205-b. For example, the system information for connecting to the second cell 205-b may include one or more RACH sequences for transmitting a RACH message, resources associated with RACH occasions, one or more random access response search space configurations, a quantity of resource occasions in frequency, one or more second cell identifiers, or any combination thereof.

Subsequently, and using the received system information, the UE 115-a may transmit, to the first cell 205-a, a RACH preamble message 235 associated with the second cell 205-b. The RACH preamble message 235 may be transmitted on a carrier or frequency associated with the first cell 205-a (e.g., a 5G carrier/frequency).

In some cases, the first cell 205-a may transmit, to the second cell 205-b based at least in part on receiving the RACH preamble message 235, signaling 240 that forwards the RACH preamble message and a wake-up signal 245. The wake-up signal 245, when received by the second cell 205-b, may prompt the second cell 205-b to exit the idle state or deep sleep.

In some examples, the UE 115-a may monitor a physical downlink control channel (PDCCH) on the frequency of the first cell 205-a (e.g., 5G frequency). The UE 115-a may receive, based at least in part on transmitting the RACH preamble message 235, a random access response message 250-a (e.g., msg2 of the RACH procedure) that indicates an uplink resource for an uplink message (e.g., msg3 of the RACH procedure). In some cases, the random access response message 250-a may schedule the uplink message to be transmitted on a resource of the first cell 205-a (e.g., 5G frequency/carrier). The UE 115-a may transmit, to the first cell 205-a, the uplink message 255-a on the uplink resource of the first cell 205-a. In some examples, the random access response message 250-a may schedule the uplink message to be transmitted on a resource of the second cell 205-b (e.g., 6G frequency/carrier). The UE 115-a may transmit, to the second cell 205-b, the uplink message 255-b on the uplink resource of the second cell 205-b.

In some examples, the UE 115-a, after transmitting the RACH preamble message 235, may monitor a PDCCH on a resource of the second cell 205-b (e.g., 6G frequency). The UE 115-a may receive, based at least in part on transmitting the RACH preamble message 235, a random access response message 250-b (e.g., msg2) that indicates an uplink resource for an uplink message 255-b. In some cases, the random access response message 250-b may schedule the uplink message 255-b to be transmitted on a resource of the second cell 205-b (e.g., 6G frequency/carrier). The UE 115-a may transmit, to the second cell 205-b, the uplink message 255-b on the uplink resource of the second cell 205-b. For the UE 115-a to be able to monitor for the random access response message 250-b or other messages of the RACH procedure on resources of the second cell 205-b (e.g., 6G frequency/carrier), the first cell 205-a may provide CORESET or search space configuration on resources of the second cell 205-b (e.g., 6G frequency/carrier) via the extended SIB or the new SIBs.

In some cases, the UE 115-a may receive, from the first cell 205-a based at least in part on transmitting the uplink message 255-a, a downlink message (e.g., msg4 of the RACH procedure) on a downlink resource. The downlink resource may be a downlink resource of the first cell 205-a or a downlink resource of the second cell 205-b. For example, the UE 115-a may receive, from the first cell 205-a, a downlink message 260-a on a resource of the first cell 205-a (e.g., 5G frequency/carrier). In some examples, the downlink message 260-a may be used for contention resolution, the RRC connection setup may not be included in the downlink message 260-a, and the RRC connection may be sent at a later time. In some cases, the UE 115-a may receive, from the second cell 205-b, a downlink message 260-b on a resource of the second cell 205-b (e.g., 6G frequency/carrier). In some examples, the downlink message 260-b may be used for contention resolution and the RRC connection setup. After the downlink message 260-a, 260-b, the UE 115-a may be granted access to the second cell 205-b.

In some examples, the first cell 205-a, after receiving the RACH preamble message 235, may decide whether to wake up the second cell 205-b or not wake up the second cell 205-b. In some cases, the RACH preamble message 235, received by the first cell 205-a, may provide an establishment cause as part of the RRC connection request for the second cell 205-b. The first cell 205-a may decide whether to wake up the second cell 205-b by transmitting the signaling 240 that forwards the RACH preamble message and the wake-up signal 245 based on the establishment cause. The establishment cause (e.g., establishmentCause) may be a field in an RRCSetupRequest information element. The establishment cause field may provide the establishment cause for the RRC setup request in accordance with the information received from upper layers. An enumerated establishment cause may be an emergency, high priority access, mt-access, mo-signalling, mo-data, mo-voicecall, mo-videocall, mo-SMS, mps-priority access, or mcs-priority access. In some cases, the establishment cause may be provided in a sequence or an available RACH occasion of the RACH preamble message 235. For example, if the establishment cause indicates emergency, the first cell 205-a may decide to wake-up the second cell 205-b, and if the establishment cause indicates a low priority item, the first cell 205-a may not wake up the second cell 205-b.

In another example, the establishment cause may be provided as part of the uplink message 255-a (e.g., msg3). The first cell 205-a may decide whether to wake up the second cell 205-based on the establishment cause of the uplink message 255-a, and the first cell 205-a may transmit, to the second cell 305-b in response to receiving the uplink message 255-a with the establishment cause, the wake-up signal 245 and signaling 240 forwarding the RACH preamble message or the uplink message (e.g., msg3). For the example of the establishment cause as part of the uplink message 255-a, the UE 115-a requesting access to the second cell 205-b (e.g., 6G access) may perform the operations of the RACH procedures up to transmission of the uplink message 255-a (e.g., msg3) on the resources of the first cell 205-a (e.g., 5G cell using the 5G channels/procedures), and the UE 115-a may receive the downlink message 260-b (e.g., msg4) from the second cell 205-b.

In some examples, the first cell 205-a may decide whether to wake up the second cell 205-b or not wake up the second cell 205-b after receiving the RACH preamble message 235 or after receiving the uplink message 255-a (e.g., msg3). The downlink message may be provided on downlink resources depending on the decision to wake up or not wake up. The decision to wake-up the second cell 205-b may grant the UE 115-a access to the second cell 205-b. The decision not to wake-up the second cell 205-b may not grant the UE 115-a access to the second cell 205-b, and the UE 115-a may access the first cell 205-a rather than the second cell 205-b.

In some cases, the UE 115-a may monitor a downlink resource of the first cell 205-a (e.g., 5G PDCCH) for the downlink message 260-a (e.g., msg4). The UE 115-a may receive the downlink message 260-a on the downlink resource of the first cell 205-a. If access to the second cell 205-b (e.g., 6G access) is granted, the downlink message includes an RRC container with RRC information for the second cell 205-b. If access to the second cell 205-b is not granted, the UE 115-a may access the first cell 205-a and receive RRC information of the first cell 205-a as part of the downlink message.

In some cases, the UE 115-a may monitor a downlink resource of the first cell 205-a (e.g., 5G PDCCH) for the downlink message 260-a (e.g., msg4). The indication of whether access to the second cell 205-b (e.g., 6G access) is granted may be provided via physical (PHY) layer signaling. For example, the indication of whether access to the second cell 205-b may be provided using different radio network temporary identifiers (RNTIs), different downlink control information (DCI) formats, different DCI sizes, or an indication in DCI, search space separation or CORESET separation. For example, the UE 115-a may monitor for RNTI or DCI to receive the indication of granted access to the second cell 205-b without receiving the downlink message 260-a (e.g., msg4) or decoding the downlink message.

In some examples, the UE 115-a may be configured to monitor a downlink resource of the first cell 205-a (e.g., 5G PDCCH) and a downlink resource of the second cell 205-b (e.g., 6G PDCCH) for the downlink message (e.g., msg4). The indication of whether access to the second cell 205-b (e.g., 6G access) is granted may be inferred from on which downlink resource the DCI scheduling the downlink message (e.g., msg4) is received. If the DCI scheduling the downlink message is received on the resource of the second cell 205-b, the access to the second cell 205-b (e.g., 6G access) may be granted, and the UE 115-a may review the downlink message 260-b on the downlink resource of the second cell 205-b using a MAC-CE or RRC. If the access to the second cell 205-b is granted, the UE 115-a may be indicated to fall back to accessing the first cell 205-a in the future. If the DCI scheduling the downlink message is received on the resource of the first cell 205-a, the access to the second cell 205-b (e.g., 6G access) may not be granted, and the UE 115-a may review the downlink message 260-a on the downlink resource of the first cell 205-a.

In the case with the establishment cause included in the RACH preamble message 235 or when the first cell 205-a may decide to move access to the second cell 205-b for the purpose of load balancing, the RACH preamble message 235 may be receive by the UE 115-a from the first cell 205-a. In response to receiving the RACH preamble message 235, the UE 115-a may receive the random access response message 250-a on a resource of the first cell 205-a from the first cell 205-a. The random access response message 250-a may indicate an uplink resource of the second cell 205-b for the uplink message 255-b. Receiving the grant for the uplink message 255-b on the resource of the second cell 205-b may be an indication of granting access to the second cell 205-b, and the downlink message 260-b may be received by the UE 115-a on a downlink resource of the second cell 205-b.

Subsequent to establishing access to the second cell 205-b, the UE 115-a may communicate with the second cell 205-b. If access to the second cell 205-b is not granted, the UE 115-a may establish access to the first cell 205-a and may communicate with the first cell 205-a.

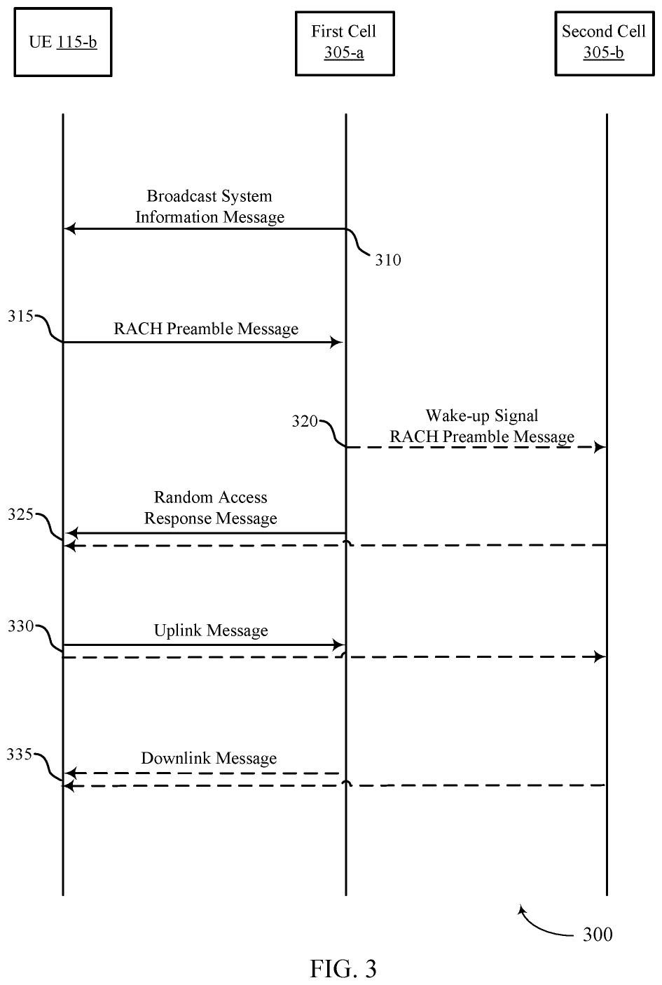

FIG. 3 shows an example of a process flow 300 that supports techniques for assisted access to a serving cell for wireless communications in accordance with one or more aspects of the present disclosure. In some examples, the process flow 300 may implement or be implemented by aspects of the wireless communications systems 100 and 200 as described with reference to FIGS. 1 and 2, respectively. For example, the process flow 300 may be implemented by a UE 115-b, which may be an example of the UEs as described with reference to FIGS. 1 and 2. For example, the process flow 300 may be implemented by a first cell 305-a, which may be an example of the first cell 205-a as described with reference to FIG. 2. For example, the process flow 300 may be implemented by a second cell 405-b, which may be an example of the first cell 205-a as described with reference to FIG. 2. In some examples, the first cell 305-a may be associated with a first RAT, and the second cell 305-b may be associated with a second RAT. In some examples, the first RAT may be a 5G RAT or NR RAT, and the second RAT may be a 6G RAT.

In some examples, the operations illustrated in process flow 300 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 310, the UE 115-b, may receive a broadcast system information message. In some examples, the first cell 305-a may transmit the broadcast system information message. The broadcast system information message may include system information for connecting to the second cell 305-b. The broadcast system information message may include a SSB message, a SIB message, or any combination thereof. The system information for connecting to the second cell 305-b may include one or more RACH sequences for transmitting a RACH message, resources associated with RACH occasions, one or more random access response search space configurations, a quantity of resource occasions in frequency, one or more second serving cell identifiers, or any combination thereof.

At 315, the UE 115-b may transmit, to the first cell 305-a, based at least in part on receiving the broadcast system information message, a RACH preamble message associated with the second cell 305-b. In some examples, the RACH preamble message may indicate an establishment cause associated with the UE 115-b requesting to connect to the second cell 305-b.

At 320, the first cell 305-a may transmit, to the second cell 305-b based at least in part on receiving the RACH preamble message, the RACH preamble message and a wake-up signal for the second cell 305-b.

At 325, the UE 115-b may receive, based at least in part on transmitting the RACH preamble message, a random access response message that indicates an uplink resource. In some examples, the uplink resource is an uplink resource of the first cell 305-a. In some examples, the uplink resource is an uplink resource of the second cell 305-b. In some cases, the first cell 305-a may transmit, to the UE 115-b in response to receiving the RACH preamble message, the random access response message that indicates the uplink resource. In some cases, the second cell 305-b may transmit, to the UE 115-b in response to receiving the RACH preamble message and the wake-up signal, the random access response message that indicates the uplink resource.

At 330, the UE 115-b may transmit, in response to receiving the random access response message, an uplink message on the uplink resource. In some examples, the uplink resource is an uplink resource of the first cell 305-a. In some examples, the uplink resource is an uplink resource of the second cell 305-b. In some examples, the uplink message may indicate an establishment cause associated with the UE 115-b requesting to connect to the second cell 305-b. In some examples, the first cell 305-a may transmit, to the second cell 305-b in response to receiving the uplink message, the wake-up signal. In some cases, the first cell 305-a may transmit to the second cell 305-b, the RACH preamble message or the uplink message.

At 335, the UE 115-b may receive, based at least in part on transmitting the uplink message, a downlink message on a downlink resource. In some examples, the downlink resource is a downlink resource of the first cell 305-a. In some examples, the downlink resource is a downlink resource of the second cell 305-b. In some examples, the downlink message includes an RRC container of the first cell 305-a. In some examples, the downlink message includes an RRC container of the second cell 305-b. In some cases, the downlink message is a physical layer message that indicates access to the second cell 205-b. In some cases, the downlink message indicates granted access to the second cell 205-b.

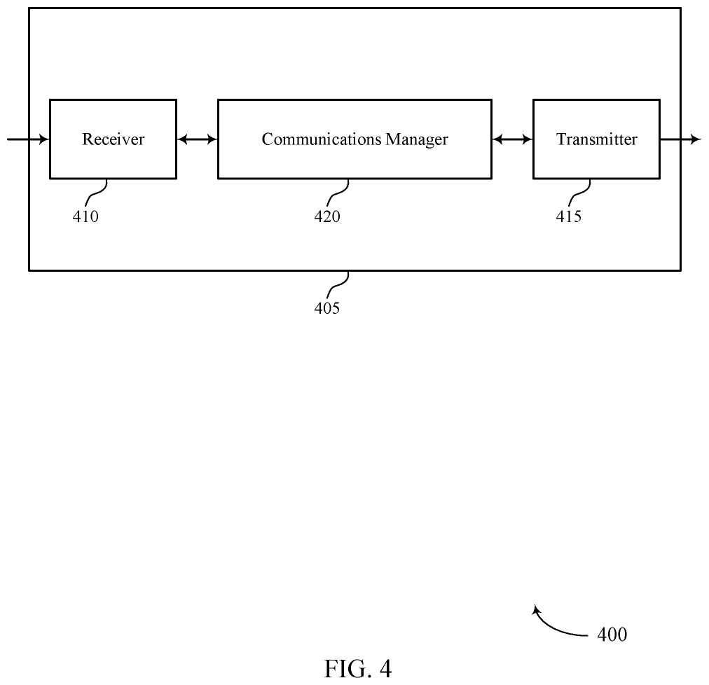

FIG. 4 shows a block diagram 400 of a device 405 that supports techniques for assisted access to a serving cell for wireless communications in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, and the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for assisted access to a serving cell for wireless communications). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for assisted access to a serving cell for wireless communications). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for assisted access to a serving cell for wireless communications as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor. If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 is capable of, configured to, or operable to support a means for receiving, from a first serving cell, a broadcast system information message, where the broadcast system information message includes system information for connecting to a second serving cell, and where the broadcast system information message includes a synchronization signal block message, a system information block message, or any combination thereof. The communications manager 420 is capable of, configured to, or operable to support a means for transmitting, to the first serving cell based on receiving the broadcast system information message, a RACH preamble message associated with the second serving cell. The communications manager 420 is capable of, configured to, or operable to support a means for receiving, from the first serving cell based on transmitting the RACH preamble message, a random access response message that indicates an uplink resource. The communications manager 420 is capable of, configured to, or operable to support a means for transmitting, to the first serving cell in response to receiving the random access response message, an uplink message on the uplink resource.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption and more efficient utilization of communication resources.

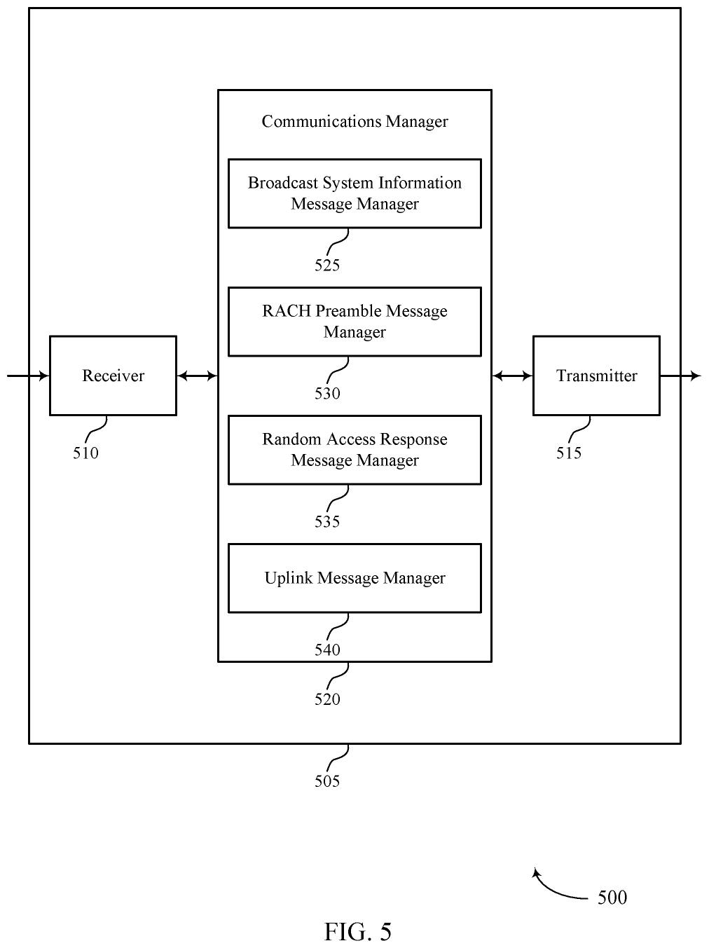

FIG. 5 shows a block diagram 500 of a device 505 that supports techniques for assisted access to a serving cell for wireless communications in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for assisted access to a serving cell for wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for assisted access to a serving cell for wireless communications). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for assisted access to a serving cell for wireless communications as described herein. For example, the communications manager 520 may include a broadcast system information message manager 525, a RACH preamble message manager 530, a random access response message manager 535, an uplink message manager 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The broadcast system information message manager 525 is capable of, configured to, or operable to support a means for receiving, from a first serving cell, a broadcast system information message, where the broadcast system information message includes system information for connecting to a second serving cell, and where the broadcast system information message includes a synchronization signal block message, a system information block message, or any combination thereof. The RACH preamble message manager 530 is capable of, configured to, or operable to support a means for transmitting, to the first serving cell based on receiving the broadcast system information message, a RACH preamble message associated with the second serving cell. The random access response message manager 535 is capable of, configured to, or operable to support a means for receiving, from the first serving cell based on transmitting the RACH preamble message, a random access response message that indicates an uplink resource. The uplink message manager 540 is capable of, configured to, or operable to support a means for transmitting, to the first serving cell in response to receiving the random access response message, an uplink message on the uplink resource.

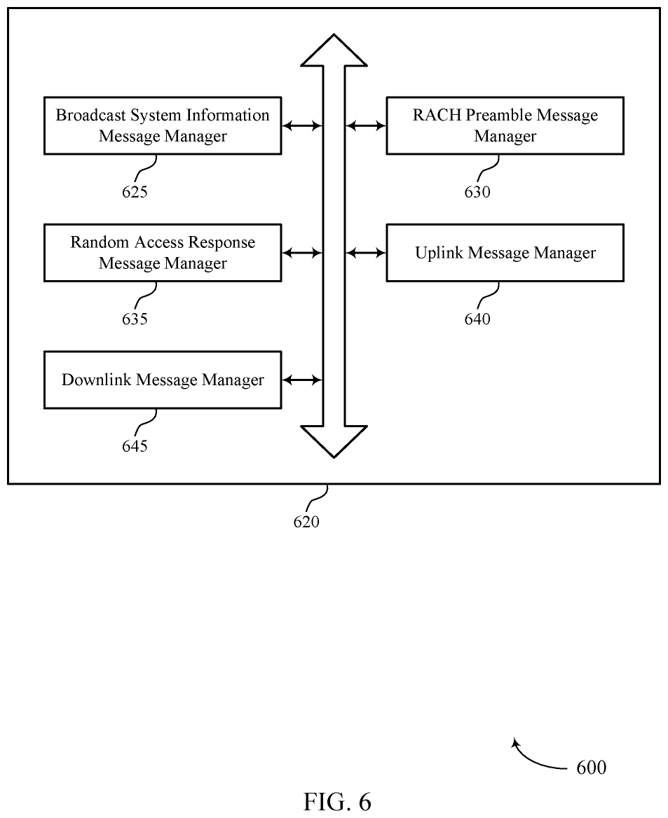

FIG. 6 shows a block diagram 600 of a communications manager 620 that supports techniques for assisted access to a serving cell for wireless communications in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for assisted access to a serving cell for wireless communications as described herein. For example, the communications manager 620 may include a broadcast system information message manager 625, a RACH preamble message manager 630, a random access response message manager 635, an uplink message manager 640, a downlink message manager 645, or any combination thereof. Each of these components, or components or subcomponents thereof (e.g., one or more processors, one or more memories), may communicate, directly or indirectly, with one another (e.g., via one or more buses).

The communications manager 620 may support wireless communication in accordance with examples as disclosed herein. The broadcast system information message manager 625 is capable of, configured to, or operable to support a means for receiving, from a first serving cell, a broadcast system information message, where the broadcast system information message includes system information for connecting to a second serving cell, and where the broadcast system information message includes a synchronization signal block message, a system information block message, or any combination thereof. The RACH preamble message manager 630 is capable of, configured to, or operable to support a means for transmitting, to the first serving cell based on receiving the broadcast system information message, a RACH preamble message associated with the second serving cell. The random access response message manager 635 is capable of, configured to, or operable to support a means for receiving, from the first serving cell based on transmitting the RACH preamble message, a random access response message that indicates an uplink resource. The uplink message manager 640 is capable of, configured to, or operable to support a means for transmitting, to the first serving cell in response to receiving the random access response message, an uplink message on the uplink resource.

In some examples, the system information for connecting to the second serving cell includes one or more random access channel sequences for transmitting a random access channel message, resources associated with random access channel occasions, one or more random access response search space configurations, a quantity of resource occasions in frequency, one or more second serving cell identifiers, or any combination thereof.

In some examples, the uplink resource is an uplink resource of the first serving cell, and the downlink message manager 645 is capable of, configured to, or operable to support a means for receiving, based on transmitting the uplink message, a downlink message on a downlink resource, where the downlink resource is a downlink resource of the first serving cell or a downlink resource of the second serving cell.

In some examples, the uplink resource is an uplink resource of the second serving cell, and the downlink message manager 645 is capable of, configured to, or operable to support a means for receiving, based on transmitting the uplink message, a downlink message on a downlink resource, where the downlink resource is a downlink resource of the second serving cell.

In some examples, the RACH preamble message or the uplink message indicates an establishment cause associated with the UE requesting to connect to the second serving cell.

In some examples, the downlink message manager 645 is capable of, configured to, or operable to support a means for receiving, based on transmitting the uplink message, a downlink message on a downlink resource, where the downlink resource is a downlink resource of the first serving cell.

In some examples, the downlink message includes an RRC container of the second serving cell.

In some examples, the downlink message includes an RRC container of the first serving cell.

In some examples, the downlink message is a physical layer message that indicates access to the second serving cell.

In some examples, the RACH preamble message or the uplink message indicates an establishment cause associated with the UE requesting to connect to the second serving cell, and the downlink message manager 645 is capable of, configured to, or operable to support a means for receiving, based on receiving the random access response message, a downlink message on the downlink resource of the second serving cell that indicates granted access to the second serving cell.

In some examples, the RACH preamble message indicates an establishment cause associated with the UE requesting to connect to the second serving cell, and the downlink message manager 645 is capable of, configured to, or operable to support a means for receiving, based on receiving the random access response message, a downlink message on the downlink resource of the second serving cell that indicates granted access to the second serving cell.

In some examples, the first serving cell and the second serving cell are supported by a same network entity.

In some examples, the first serving cell is associated with a first radio access technology. In some examples, the second serving cell is associated with a second radio access technology.

In some examples, the first radio access technology includes a Fifth Generation radio access technology, a New Radio access technology, or both. In some examples, the second radio access technology includes a Sixth Generation radio access technology.

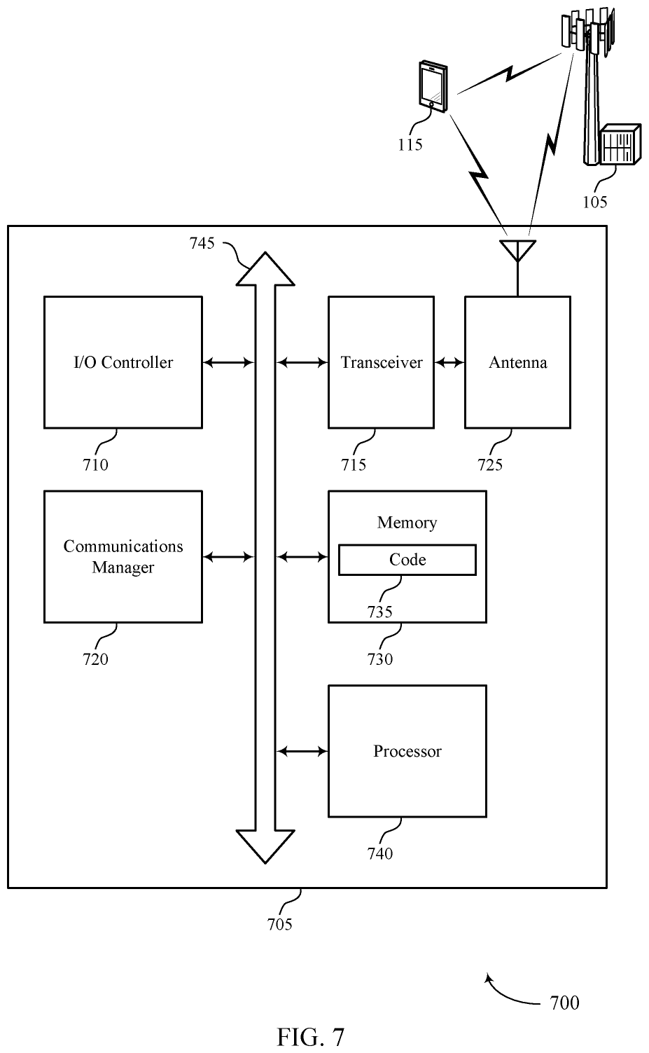

FIG. 7 shows a diagram of a system 700 including a device 705 that supports techniques for assisted access to a serving cell for wireless communications in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable code 735 including instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for assisted access to a serving cell for wireless communications). For example, the device 705 or a component of the device 705 may include at least one processor 740 and at least one memory 730 coupled with or to the at least one processor 740, the at least one processor 740 and at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. As such, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 730 or otherwise, to perform one or more of the functions described herein.

The communications manager 720 may support wireless communication in accordance with examples as disclosed herein. For example, the communications manager 720 is capable of, configured to, or operable to support a means for receiving, from a first serving cell, a broadcast system information message, where the broadcast system information message includes system information for connecting to a second serving cell, and where the broadcast system information message includes a synchronization signal block message, a system information block message, or any combination thereof. The communications manager 720 is capable of, configured to, or operable to support a means for transmitting, to the first serving cell based on receiving the broadcast system information message, a RACH preamble message associated with the second serving cell. The communications manager 720 is capable of, configured to, or operable to support a means for receiving, from the first serving cell based on transmitting the RACH preamble message, a random access response message that indicates an uplink resource. The communications manager 720 is capable of, configured to, or operable to support a means for transmitting, to the first serving cell in response to receiving the random access response message, an uplink message on the uplink resource.

By including or configuring the communications manager 720 in accordance with examples as described herein, the device 705 may support techniques for reduced power consumption, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for assisted access to a serving cell for wireless communications as described herein, or the at least one processor 740 and the at least one memory 730 may be otherwise configured to, individually or collectively, perform or support such operations.

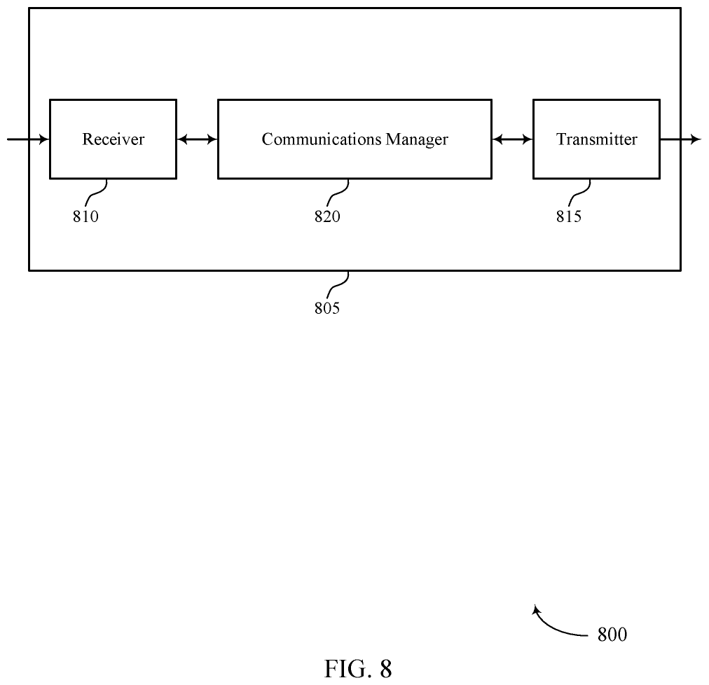

FIG. 8 shows a block diagram 800 of a device 805 that supports techniques for assisted access to a serving cell for wireless communications in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of techniques for assisted access to a serving cell for wireless communications as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. For example, the communications manager 820 is capable of, configured to, or operable to support a means for transmitting a broadcast system information message, where the broadcast system information message includes system information for connecting to a second serving cell, where the broadcast system information message includes a synchronization signal block message, a system information block message, or any combination thereof. The communications manager 820 is capable of, configured to, or operable to support a means for receiving, from a UE based on transmitting the broadcast system information message, a RACH preamble message associated with the second serving cell. The communications manager 820 is capable of, configured to, or operable to support a means for transmitting, to the UE in response to receiving the RACH preamble message, a random access response message that indicates an uplink resource.

Additionally, or alternatively, the communications manager 820 may support wireless communication in accordance with examples as disclosed herein. For example, the communications manager 820 is capable of, configured to, or operable to support a means for receiving, from a first serving cell, a wake-up signal that indicates the second serving cell to wake-up from a sleep state. The communications manager 820 is capable of, configured to, or operable to support a means for receiving, from the first serving cell, a RACH preamble message associated with a UE and associated with the wake-up signal. The communications manager 820 is capable of, configured to, or operable to support a means for communicating with the UE or the first serving cell based on receiving the RACH preamble message and the wake-up signal.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption, more efficient utilization of communication resources

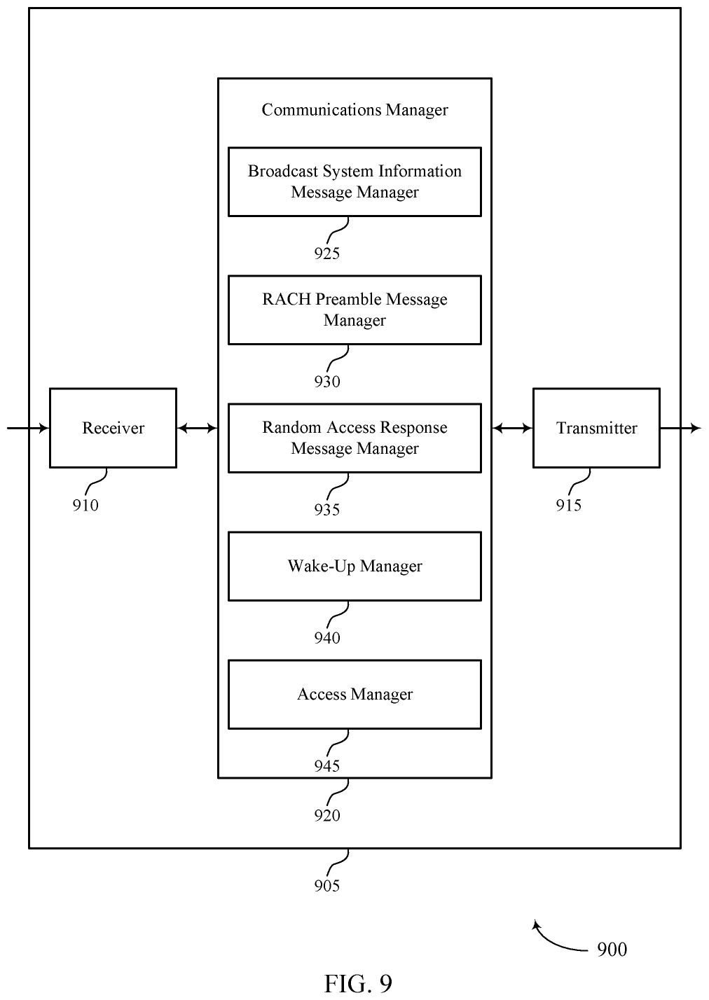

FIG. 9 shows a block diagram 900 of a device 905 that supports techniques for assisted access to a serving cell for wireless communications in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for assisted access to a serving cell for wireless communications as described herein. For example, the communications manager 920 may include a broadcast system information message manager 925, a RACH preamble message manager 930, a random access response message manager 935, a wake up manager 940, an access granted manager 945, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. The broadcast system information message manager 925 is capable of, configured to, or operable to support a means for transmitting a broadcast system information message, where the broadcast system information message includes system information for connecting to a second serving cell, where the broadcast system information message includes a synchronization signal block message, a system information block message, or any combination thereof. The RACH preamble message manager 930 is capable of, configured to, or operable to support a means for receiving, from a UE based on transmitting the broadcast system information message, a RACH preamble message associated with the second serving cell. The random access response message manager 935 is capable of, configured to, or operable to support a means for transmitting, to the UE in response to receiving the RACH preamble message, a random access response message that indicates an uplink resource.

Additionally, or alternatively, the communications manager 920 may support wireless communication in accordance with examples as disclosed herein. The wake up manager 940 is capable of, configured to, or operable to support a means for receiving, from a first serving cell, a wake-up signal that indicates the second serving cell to wake-up from a sleep state. The RACH preamble message manager 930 is capable of, configured to, or operable to support a means for receiving, from the first serving cell, a RACH preamble message associated with a UE and associated with the wake-up signal. The access granted manager 945 is capable of, configured to, or operable to support a means for communicating with the UE or the first serving cell based on receiving the RACH preamble message and the wake-up signal.

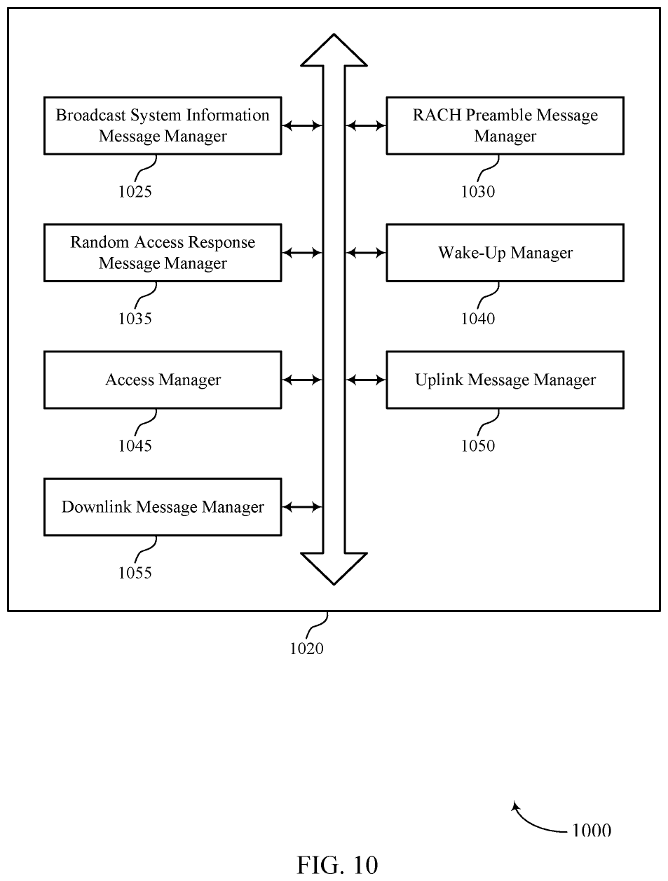

FIG. 10 shows a block diagram 1000 of a communications manager 1020 that supports techniques for assisted access to a serving cell for wireless communications in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for assisted access to a serving cell for wireless communications as described herein. For example, the communications manager 1020 may include a broadcast system information message manager 1025, a RACH preamble message manager 1030, a random access response message manager 1035, a wake up manager 1040, an access granted manager 1045, an uplink message manager 1050, a downlink message manager 1055, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication in accordance with examples as disclosed herein. The broadcast system information message manager 1025 is capable of, configured to, or operable to support a means for transmitting a broadcast system information message, where the broadcast system information message includes system information for connecting to a second serving cell, where the broadcast system information message includes a synchronization signal block message, a system information block message, or any combination thereof. The RACH preamble message manager 1030 is capable of, configured to, or operable to support a means for receiving, from a UE based on transmitting the broadcast system information message, a RACH preamble message associated with the second serving cell. The random access response message manager 1035 is capable of, configured to, or operable to support a means for transmitting, to the UE in response to receiving the RACH preamble message, a random access response message that indicates an uplink resource.

In some examples, the system information for connecting to the second serving cell includes one or more random access channel sequences for transmitting a random access channel message, resources associated with random access channel occasions, one or more random access response search space configurations, a quantity of resource occasions in frequency, one or more second serving cell identifiers, or any combination thereof.

In some examples, the wake up manager 1040 is capable of, configured to, or operable to support a means for transmitting, to the second serving cell based on receiving the RACH preamble message, the RACH preamble message and a wake-up signal for the second serving cell.

In some examples, the uplink resource is an uplink resource of the first serving cell, and the uplink message manager 1050 is capable of, configured to, or operable to support a means for receiving, based on transmitting the random access response message, an uplink message on the uplink resource.

In some examples, the downlink message manager 1055 is capable of, configured to, or operable to support a means for transmitting, based on receiving the uplink message, a downlink message on a downlink resource of the first serving cell.

In some examples, the downlink message includes an RRC container of the second serving cell.

In some examples, the downlink message includes an RRC container of the first serving cell.

In some examples, the downlink message is a physical layer message that indicate access to the second serving cell.

In some examples, the RACH preamble message indicates an establishment cause for connecting to the second serving cell or the uplink message indicates an establishment cause for connecting to a second serving cell and the random access response message indicates a downlink resource of the first serving cell and a downlink resource of the second serving cell.

In some examples, the RACH preamble message or the uplink message indicates an establishment cause associated with the UE requesting to connect to the second serving cell, and the wake up manager 1040 is capable of, configured to, or operable to support a means for transmitting, to the second serving cell based on receiving the establishment cause, a wake-up signal and the RACH preamble message.

Additionally, or alternatively, the communications manager 1020 may support wireless communication in accordance with examples as disclosed herein. The wake up manager 1040 is capable of, configured to, or operable to support a means for receiving, from a first serving cell, a wake-up signal that indicates the second serving cell to wake-up from a sleep state. In some examples, the RACH preamble message manager 1030 is capable of, configured to, or operable to support a means for receiving, from the first serving cell, a RACH preamble message associated with a UE and associated with the wake-up signal. The access granted manager 1045 is capable of, configured to, or operable to support a means for communicating with the UE or the first serving cell based on receiving the RACH preamble message and the wake-up signal.

In some examples, the random access response message manager 1035 is capable of, configured to, or operable to support a means for transmitting, to the UE based on receiving the RACH preamble message, a random access response message that indicates an uplink resource of the second serving cell.

In some examples, the uplink message manager 1050 is capable of, configured to, or operable to support a means for receiving, from the UE, an uplink message on an uplink resource of the second serving cell.

In some examples, the downlink message manager 1055 is capable of, configured to, or operable to support a means for transmitting, to the UE, a downlink message on a downlink resource of the second serving cell.

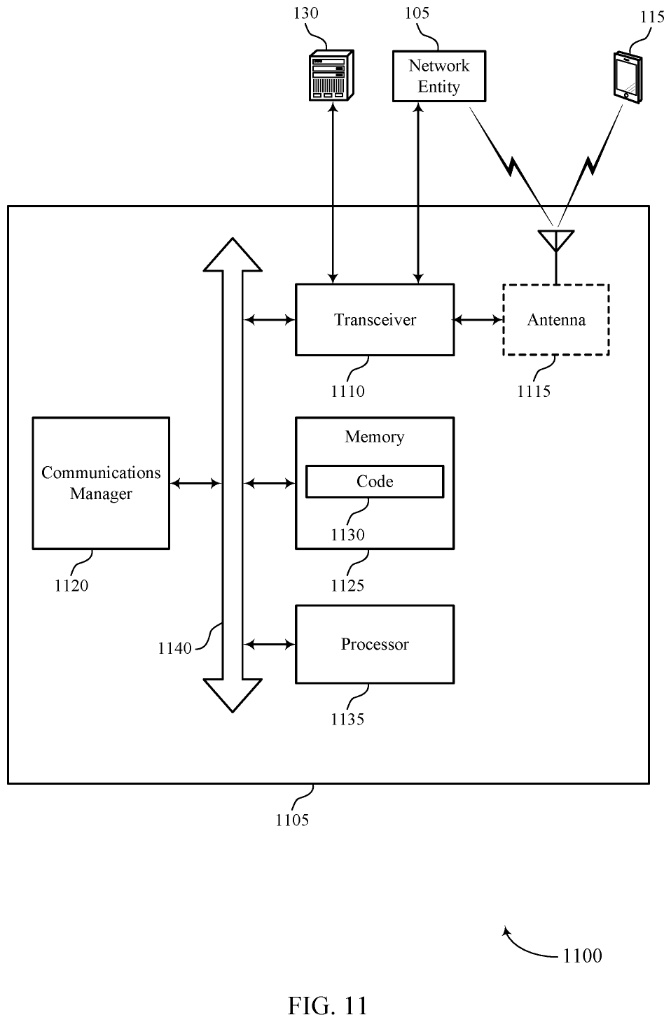

FIG. 11 shows a diagram of a system 1100 including a device 1105 that supports techniques for assisted access to a serving cell for wireless communications in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., a communication link 125, a backhaul communication link 120, a midhaul communication link 162, a fronthaul communication link 168).

The at least one memory 1125 may include RAM, ROM, or any combination thereof. The at least one memory 1125 may store computer-readable, computer-executable code 1130 including instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may contain, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for assisted access to a serving cell for wireless communications). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. As such, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication in accordance with examples as disclosed herein. For example, the communications manager 1120 is capable of, configured to, or operable to support a means for transmitting a broadcast system information message, where the broadcast system information message includes system information for connecting to a second serving cell, where the broadcast system information message includes a synchronization signal block message, a system information block message, or any combination thereof. The communications manager 1120 is capable of, configured to, or operable to support a means for receiving, from a UE based on transmitting the broadcast system information message, a RACH preamble message associated with the second serving cell. The communications manager 1120 is capable of, configured to, or operable to support a means for transmitting, to the UE in response to receiving the RACH preamble message, a random access response message that indicates an uplink resource.

Additionally, or alternatively, the communications manager 1120 may support wireless communication in accordance with examples as disclosed herein. For example, the communications manager 1120 is capable of, configured to, or operable to support a means for receiving, from a first serving cell, a wake-up signal that indicates the second serving cell to wake-up from a sleep state. The communications manager 1120 is capable of, configured to, or operable to support a means for receiving, from the first serving cell, a RACH preamble message associated with a UE and associated with the wake-up signal. The communications manager 1120 is capable of, configured to, or operable to support a means for communicating with the UE or the first serving cell based on receiving the RACH preamble message and the wake-up signal.

By including or configuring the communications manager 1120 in accordance with examples as described herein, the device 1105 may support techniques for reduced power consumption, more efficient utilization of communication resources, improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for assisted access to a serving cell for wireless communications as described herein, or the at least one processor 1135 and the at least one memory 1125 may be otherwise configured to, individually or collectively, perform or support such operations.

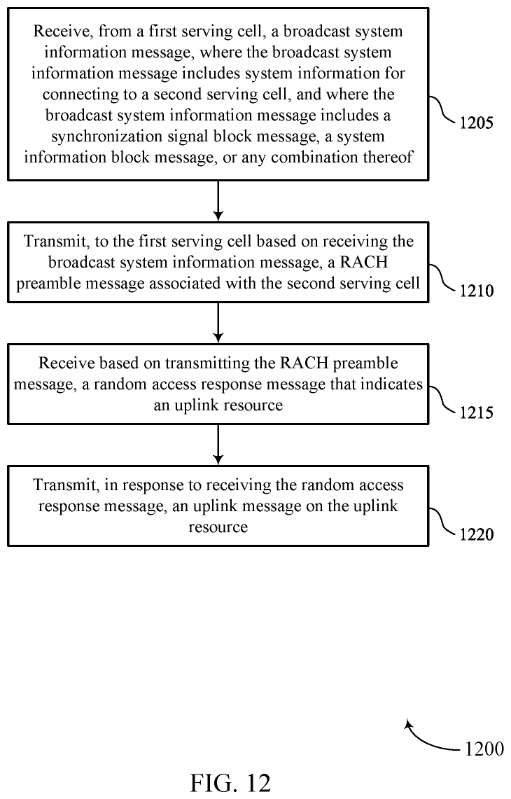

FIG. 12 shows a flowchart illustrating a method 1200 that supports techniques for assisted access to a serving cell for wireless communications in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving, from a first serving cell, a broadcast system information message, where the broadcast system information message includes system information for connecting to a second serving cell, and where the broadcast system information message includes a synchronization signal block message, a system information block message, or any combination thereof. The operations of block 1205 may be performed in accordance with examples as disclosed herein. In some examples, aspects of the operations of 1205 may be performed by a broadcast system information message manager 625 as described with reference to FIG. 6.

At 1210, the method may include transmitting, to the first serving cell based on receiving the broadcast system information message, a RACH preamble message associated with the second serving cell. The operations of block 1210 may be performed in accordance with examples as disclosed herein. In some examples, aspects of the operations of 1210 may be performed by a RACH preamble message manager 630 as described with reference to FIG. 6.

At 1215, the method may include receiving, from the first serving cell based on transmitting the RACH preamble message, a random access response message that indicates an uplink resource. The operations of block 1215 may be performed in accordance with examples as disclosed herein. In some examples, aspects of the operations of 1215 may be performed by a random access response message manager 635 as described with reference to FIG. 6.

At 1220, the method may include transmitting, to the first serving cell in response to receiving the random access response message, an uplink message on the uplink resource. The operations of block 1220 may be performed in accordance with examples as disclosed herein. In some examples, aspects of the operations of 1220 may be performed by an uplink message manager 640 as described with reference to FIG. 6.

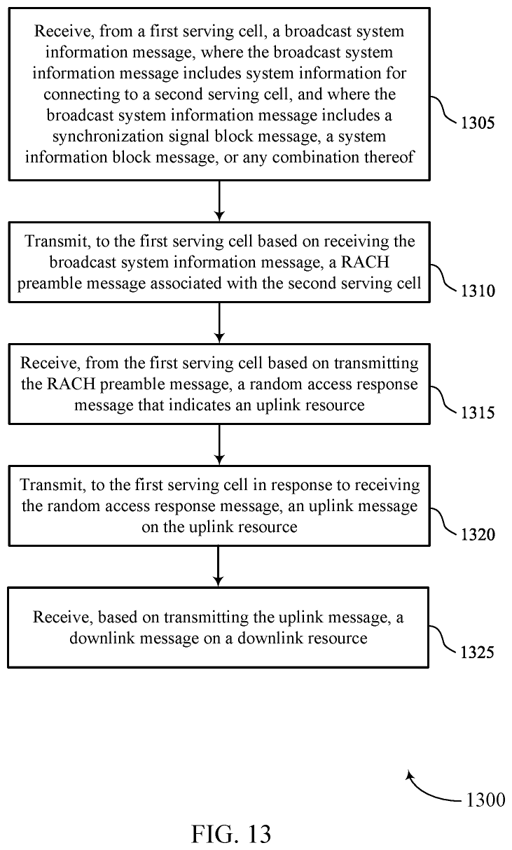

FIG. 13 shows a flowchart illustrating a method 1300 that supports techniques for assisted access to a serving cell for wireless communications in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving, from a first serving cell, a broadcast system information message, where the broadcast system information message includes system information for connecting to a second serving cell, and where the broadcast system information message includes a synchronization signal block message, a system information block message, or any combination thereof. The operations of block 1305 may be performed in accordance with examples as disclosed herein. In some examples, aspects of the operations of 1305 may be performed by a broadcast system information message manager 625 as described with reference to FIG. 6.

At 1310, the method may include transmitting, to the first serving cell based on receiving the broadcast system information message, a RACH preamble message associated with the second serving cell. The operations of block 1310 may be performed in accordance with examples as disclosed herein. In some examples, aspects of the operations of 1310 may be performed by a RACH preamble message manager 630 as described with reference to FIG. 6.

At 1315, the method may include receiving, from the first serving cell based on transmitting the RACH preamble message, a random access response message that indicates an uplink resource. The operations of block 1315 may be performed in accordance with examples as disclosed herein. In some examples, aspects of the operations of 1315 may be performed by a random access response message manager 635 as described with reference to FIG. 6.

At 1320, the method may include transmitting, to the first serving cell in response to receiving the random access response message, an uplink message on the uplink resource. The operations of block 1320 may be performed in accordance with examples as disclosed herein. In some examples, aspects of the operations of 1320 may be performed by an uplink message manager 640 as described with reference to FIG. 6.

At 1325, the method may include receiving, based on transmitting the uplink message, a downlink message on a downlink resource. The operations of block 1325 may be performed in accordance with examples as disclosed herein. In some examples, aspects of the operations of 1325 may be performed by a downlink message manager 645 as described with reference to FIG. 6.

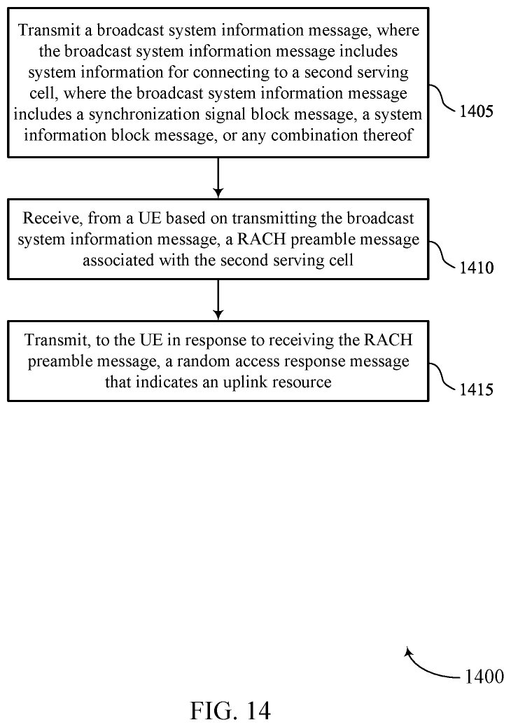

FIG. 14 shows a flowchart illustrating a method 1400 that supports techniques for assisted access to a serving cell for wireless communications in accordance with aspects of the present disclosure. The operations of the method 1400 may be implemented by a network entity or its components as described herein (e.g., by a network entity associated with a first serving cell, such as a 5G serving cell, or its components). For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include transmitting a broadcast system information message, where the broadcast system information message includes system information for connecting to a second serving cell, where the broadcast system information message includes a synchronization signal block message, a system information block message, or any combination thereof. The operations of block 1405 may be performed in accordance with examples as disclosed herein. In some examples, aspects of the operations of 1405 may be performed by a broadcast system information message manager 1025 as described with reference to FIG. 10.

At 1410, the method may include receiving, from a UE based on transmitting the broadcast system information message, a RACH preamble message associated with the second serving cell. The operations of block 1410 may be performed in accordance with examples as disclosed herein. In some examples, aspects of the operations of 1410 may be performed by a RACH preamble message manager 1030 as described with reference to FIG. 10.

At 1415, the method may include transmitting, to the UE in response to receiving the RACH preamble message, a random access response message that indicates an uplink resource. The operations of block 1415 may be performed in accordance with examples as disclosed herein. In some examples, aspects of the operations of 1415 may be performed by a random access response message manager 1035 as described with reference to FIG. 10.

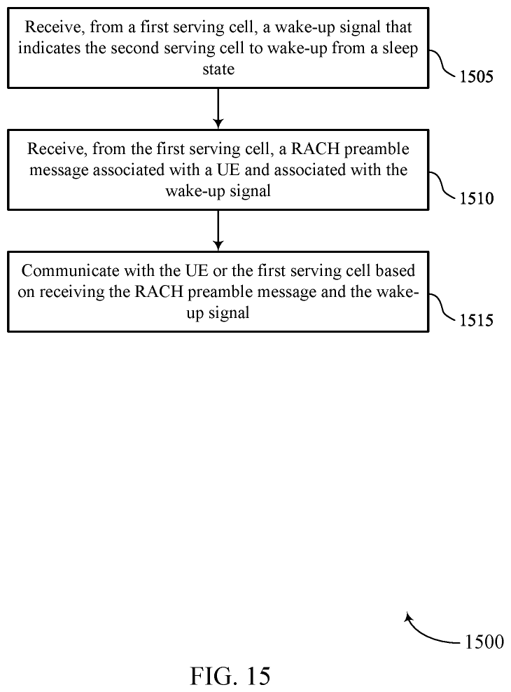

FIG. 15 shows a flowchart illustrating a method 1500 that supports techniques for assisted access to a serving cell for wireless communications in accordance with aspects of the present disclosure. The operations of the method 1500 may be implemented by a network entity or its components as described herein (e.g., by a network entity associated with a second serving cell, such as a 6G serving cell, or its components). For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include receiving, from a first serving cell, a wake-up signal that indicates the second serving cell to wake-up from a sleep state. The operations of block 1505 may be performed in accordance with examples as disclosed herein. In some examples, aspects of the operations of 1505 may be performed by a wake up manager 1040 as described with reference to FIG. 10.

At 1510, the method may include receiving, from the first serving cell, a RACH preamble message associated with a UE and associated with the wake-up signal. The operations of block 1510 may be performed in accordance with examples as disclosed herein. In some examples, aspects of the operations of 1510 may be performed by a RACH preamble message manager 1030 as described with reference to FIG. 10.

At 1515, the method may include communicating with the UE or the first serving cell based on receiving the RACH preamble message and the wake-up signal. The operations of block 1515 may be performed in accordance with examples as disclosed herein. In some examples, aspects of the operations of 1515 may be performed by an access granted manager 1045 as described with reference to FIG. 10.

The following provides an overview of aspects of the present disclosure:

Aspect 1: A method for wireless communication by UE, comprising: receiving, from a first serving cell, a broadcast system information message, wherein the broadcast system information message comprises system information for connecting to a second serving cell, and wherein the broadcast system information message comprises a synchronization signal block message, a system information block message, or any combination thereof; transmitting, to the first serving cell based at least in part on receiving the broadcast system information message, a RACH preamble message associated with the second serving cell; receiving based at least in part on transmitting the RACH preamble message, a random access response message that indicates an uplink resource; and transmitting, in response to receiving the random access response message, an uplink message on the uplink resource.

Aspect 2: The method of aspect 1, wherein the system information for connecting to the second serving cell comprises one or more random access channel sequences for transmitting a random access channel message, resources associated with random access channel occasions, one or more random access response search space configurations, a quantity of resource occasions in frequency, one or more second serving cell identifiers, or any combination thereof.

Aspect 3: The method of any of aspects 1 through 2, wherein the uplink resource is an uplink resource of the first serving cell, the method further comprising: receiving, based at least in part on transmitting the uplink message, a downlink message on a downlink resource, wherein the downlink resource is a downlink resource of the first serving cell or a downlink resource of the second serving cell.

Aspect 4: The method of any of aspects 1 through 2, wherein the uplink resource is an uplink resource of the second serving cell, the method further comprising: receiving, based at least in part on transmitting the uplink message, a downlink message on a downlink resource, wherein the downlink resource is a downlink resource of the second serving cell.

Aspect 5: The method of any of aspects 1 through 4, wherein the RACH preamble message or the uplink message indicates an establishment cause associated with the UE requesting to connect to the second serving cell.

Aspect 6: The method of aspect 5, further comprising: receiving, based at least in part on transmitting the uplink message, a downlink message on a downlink resource, wherein the downlink resource is a downlink resource of the first serving cell.

Aspect 7: The method of aspect 6, wherein the downlink message includes an RRC container of the second serving cell.

Aspect 8: The method of any of aspect 6, wherein the downlink message includes an RRC container of the first serving cell.

Aspect 9: The method of any of aspect 6, wherein the downlink message is a physical layer message that indicate access to the second serving cell.

Aspect 10: The method of any of aspects 1 through 9, wherein the RACH preamble message or the uplink message indicates an establishment cause associated with the UE requesting to connect to the second serving cell, and wherein the random access response message indicates a downlink resource of the first serving cell and a downlink resource of the second serving cell, the method further comprising: receiving, based at least in part on receiving the random access response message, a downlink message on the downlink resource of the second serving cell that indicates granted access to the second serving cell.

Aspect 11: The method of any of aspects 1 through 9, wherein the RACH preamble message indicates an establishment cause associated with the UE requesting to connect to the second serving cell, and wherein the random access response message indicates a downlink resource of the first serving cell or a downlink resource of the second serving cell, the method further comprising: receiving, based at least in part on receiving the random access response message, a downlink message on the downlink resource of the second serving cell that indicates granted access to the second serving cell.

Aspect 12: The method of any of aspects 1 through 11, wherein the first serving cell and the second serving cell are supported by a same network entity.

Aspect 13: The method of any of aspects 1 through 12, wherein the first serving cell is associated with a first radio access technology, and the second serving cell is associated with a second radio access technology.

Aspect 14: The method of aspect 13, wherein the first radio access technology comprises a Fifth Generation radio access technology, a New Radio access technology, or both, and the second radio access technology comprises a Sixth Generation radio access technology.

Aspect 15: A method for wireless communication by a first serving cell, comprising: transmitting a broadcast system information message, wherein the broadcast system information message comprises system information for connecting to a second serving cell, wherein the broadcast system information message comprises a synchronization signal block message, a system information block message, or any combination thereof; receiving, from a UE based at least in part on transmitting the broadcast system information message, a RACH preamble message associated with the second serving cell; and transmitting, to the UE in response to receiving the RACH preamble message, a random access response message that indicates an uplink resource.

Aspect 16: The method of aspect 15, wherein the system information for connecting to the second serving cell comprises one or more random access channel sequences for transmitting a random access channel message, resources associated with random access channel occasions, one or more random access response search space configurations, a quantity of resource occasions in frequency, one or more second serving cell identifiers, or any combination thereof.

Aspect 17: The method of any of aspects 15 through 16, further comprising: transmitting, to the second serving cell based at least in part on receiving the RACH preamble message, the RACH preamble message and a wake-up signal for the second serving cell.

Aspect 18: The method of any of aspects 15 through 17, wherein the uplink resource is an uplink resource of the first serving cell, the method further comprising: receiving, based at least in part on transmitting the random access response message, an uplink message on the uplink resource.

Aspect 19: The method of aspect 18, further comprising: transmitting, based at least in part on receiving the uplink message, a downlink message on a downlink resource of the first serving cell.

Aspect 20: The method of aspect 19, wherein the downlink message includes an RRC container of the second serving cell.

Aspect 21: The method of any of aspects 19 through 20, wherein the downlink message includes an RRC container of the first serving cell.

Aspect 22: The method of any of aspects 19 through 21, wherein the downlink message is a physical layer message that indicate access to the second serving cell.

Aspect 23: The method of aspect 22, wherein the RACH preamble message indicates an establishment cause for connecting to the second serving cell or the uplink message indicates an establishment cause for connecting to a second serving cell and the random access response message indicates a downlink resource of the first serving cell and a downlink resource of the second serving cell.

Aspect 24: The method of any of aspects 18 through 23, wherein the RACH preamble message or the uplink message indicates an establishment cause associated with the UE requesting to connect to the second serving cell, the method further comprising: transmitting, to the second serving cell based at least in part on receiving the establishment cause, a wake-up signal and the RACH preamble message.

Aspect 25: A method for wireless communication by a second serving cell, comprising: receiving, from a first serving cell, a wake-up signal that indicates the second serving cell to wake-up from a sleep state; and receiving, from the first serving cell, a RACH preamble message associated with a UE and associated with the wake-up signal; communicating with the UE or the first serving cell based at least in part on receiving the RACH preamble message and the wake-up signal.

Aspect 26: The method of aspect 25, wherein communicating with the UE or the first serving cell further comprising: transmitting, to the UE based at least in part on receiving the RACH preamble message, a random access response message that indicates an uplink resource of the second serving cell.

Aspect 27: The method of any of aspects 25 through 26, wherein communicating with the UE or the first serving cell further comprising: receiving, from the UE, an uplink message on an uplink resource of the second serving cell.

Aspect 28: The method of any of aspects 25 through 27, wherein communicating with the UE or the first serving cell further comprising: transmitting, to the UE, a downlink message on a downlink resource of the second serving cell.

Aspect 29: A UE for wireless communication, comprising one or more memories storing processor-executable code, and one or more processors coupled with the one or more memories and individually or collectively operable to execute the code to cause the UE to perform a method of any of aspects 1 through 14.

Aspect 30: A UE for wireless communication, comprising at least one means for performing a method of any of aspects 1 through 14.

Aspect 31: A non-transitory computer-readable medium storing code for wireless communication, the code comprising instructions executable by a processor to perform a method of any of aspects 1 through 14.

Aspect 32: A network entity associated with a first serving cell for wireless communication, comprising one or more memories storing processor-executable code, and one or more processors coupled with the one or more memories and individually or collectively operable to execute the code to cause the network entity to, via the first serving cell, perform a method of any of aspects 15 through 24.

Aspect 33: A network entity associated with a first serving cell for wireless communication, comprising at least one means for performing a method of any of aspects 15 through 24.

Aspect 34: A non-transitory computer-readable medium storing code for wireless communication, the code comprising instructions executable by a processor to perform a method of any of aspects 15 through 24.

Aspect 35: A network entity associated with a second serving cell for wireless communication, comprising one or more memories storing processor-executable code, and one or more processors coupled with the one or more memories and individually or collectively operable to execute the code to cause the network entity to, via the second serving cell, perform a method of any of aspects 25 through 28.

Aspect 36: A network entity associated with a second serving cell for wireless communication, comprising at least one means for performing a method of any of aspects 25 through 28.

Aspect 37: A non-transitory computer-readable medium storing code for wireless communication, the code comprising instructions executable by a processor to perform a method of any of aspects 25 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a first serving cell, a broadcast system information message, wherein the broadcast system information message comprises system information for connecting to a second serving cell, and wherein the broadcast system information message comprises a synchronization signal block message, a system information block message, or any combination thereof;
transmit, to the first serving cell based at least in part on receiving the broadcast system information message, a RACH preamble message associated with the second serving cell;
receive, based at least in part on transmitting the RACH preamble message, a random access response message that indicates an uplink resource; and
transmit, in response to receiving the random access response message, an uplink message on the uplink resource.

2. The UE of claim 1, wherein the system information for connecting to the second serving cell comprises one or more random access channel sequences for transmitting a random access channel message, resources associated with random access channel occasions, one or more random access response search space configurations, a quantity of resource occasions in frequency, one or more second serving cell identifiers, or any combination thereof.

3. The UE of claim 1, wherein the uplink resource is an uplink resource of the first serving cell, and wherein the one or more processors are individually or collectively further operable to execute the code to cause the UE to:
receive, based at least in part on transmitting the uplink message, a downlink message on a downlink resource, wherein the downlink resource is a downlink resource of the first serving cell or a downlink resource of the second serving cell.

4. The UE of claim 1, wherein the uplink resource is an uplink resource of the second serving cell, and wherein the one or more processors are individually or collectively further operable to execute the code to cause the UE to:
receive, based at least in part on transmitting the uplink message, a downlink message on a downlink resource, wherein the downlink resource is a downlink resource of the second serving cell.

5. The UE of claim 1, wherein the RACH preamble message or the uplink message indicates an establishment cause associated with the UE requesting to connect to the second serving cell.

6. The UE of claim 5, wherein the one or more processors are individually or collectively further operable to execute the code to cause the UE to:
receive, based at least in part on transmitting the uplink message, a downlink message on a downlink resource, wherein the downlink resource is a downlink resource of the first serving cell.

7. The UE of claim 6, wherein the downlink message includes an RRC container of the second serving cell.

8. The UE of claim 6, wherein the downlink message includes an RRC container of the first serving cell.

9. The UE of claim 6, wherein the downlink message is a physical layer message that indicates access to the second serving cell.

10. The UE of claim 1, wherein the RACH preamble message or the uplink message indicates an establishment cause associated with the UE requesting to connect to the second serving cell, and wherein the one or more processors are individually or collectively further operable to execute the code to cause the UE to:
receive, based at least in part on receiving the random access response message, a downlink message on a downlink resource of the second serving cell that indicates granted access to the second serving cell.

11. The UE of claim 1, wherein the RACH preamble message indicates an establishment cause associated with the UE requesting to connect to the second serving cell, and wherein the one or more processors are individually or collectively further operable to execute the code to cause the UE to:
receive, based at least in part on receiving the random access response message, a downlink message on a downlink resource of the second serving cell that indicates granted access to the second serving cell.

12. The UE of claim 1, wherein the first serving cell is associated with a first radio access technology, and wherein the second serving cell is associated with a second radio access technology.

13. The UE of claim 12, wherein the first radio access technology comprises a Fifth Generation radio access technology, a New Radio access technology, or both, and wherein the second radio access technology comprises a Sixth Generation radio access technology.

14. A network entity associated with a first serving cell, the network entity comprising:
one or more memories storing processor-executable code; and
one or more processors coupled with the one or more memories and individually or collectively operable to execute the code to cause the network entity to, via the first serving cell:
transmit a broadcast system information message, wherein the broadcast system information message comprises system information for connecting to a second serving cell, wherein the broadcast system information message comprises a synchronization signal block message, a system information block message, or any combination thereof;
receive, from a user equipment (UE) based at least in part on transmitting the broadcast system information message, a RACH preamble message associated with the second serving cell; and
transmit, to the UE in response to receiving the RACH preamble message, a random access response message that indicates an uplink resource.

15. The network entity of claim 14, wherein the system information for connecting to the second serving cell comprises one or more random access channel sequences for transmitting a random access channel message, resources associated with random access channel occasions, one or more random access response search space configurations, a quantity of resource occasions in frequency, one or more second serving cell identifiers, or any combination thereof.

16. The network entity of claim 14, wherein the one or more processors are individually or collectively further operable to execute the code to cause the network entity to, via the first serving cell:
transmit, to the second serving cell based at least in part on receiving the RACH preamble message, the RACH preamble message and a wake-up signal for the second serving cell.

17. The network entity of claim 14, wherein the uplink resource is an uplink resource of the first serving cell, and wherein the one or more processors are individually or collectively further operable to execute the code to cause the network entity to, via the first serving cell:
receive, based at least in part on transmitting the random access response message, an uplink message on the uplink resource.

18. The network entity of claim 17, wherein the one or more processors are individually or collectively further operable to execute the code to cause the network entity to, via the first serving cell:
transmit, based at least in part on receiving the uplink message, a downlink message on a downlink resource of the first serving cell.

19. The network entity of claim 18, wherein the downlink message includes an RRC container of the second serving cell.

20. The network entity of claim 18, wherein the downlink message includes an RRC container of the first serving cell.

21. The network entity of claim 18, wherein the downlink message is a physical layer message that indicate access to the second serving cell.

22. The network entity of claim 21, wherein:
the RACH preamble message indicates an establishment cause for connecting to the second serving cell; or
the uplink message indicates an establishment cause for connecting to the second serving cell and the random access response message indicates a downlink resource of the first serving cell and a downlink resource of the second serving cell.

23. The network entity of claim 17, wherein the RACH preamble message or the uplink message indicates an establishment cause associated with the UE requesting to connect to the second serving cell, and wherein the one or more processors are individually or collectively further operable to execute the code to cause the network entity to, via the first serving cell:
transmit, to the second serving cell based at least in part on receiving the establishment cause, a wake-up signal and the RACH preamble message.

24. A network entity associated with a second serving cell, the network entity comprising:
one or more memories storing processor-executable code; and
one or more processors coupled with the one or more memories and individually or collectively operable to execute the code to cause the network entity to, via the second serving cell:
receive, from a first serving cell, a wake-up signal that indicates the second serving cell to wake-up from a sleep state;
receive, from the first serving cell, a RACH preamble message associated with a user equipment (UE) and associated with the wake-up signal; and
communicate with the UE or the first serving cell based at least in part on receiving the RACH preamble message and the wake-up signal.

25. The network entity of claim 24, wherein the one or more processors are individually or collectively further operable to execute the code to cause the network entity to, via the second serving cell:
transmit, to the UE based at least in part on receiving the RACH preamble message, a random access response message that indicates an uplink resource of the second serving cell.

26. The network entity of claim 24, wherein the one or more processors are individually or collectively further operable to execute the code to cause the network entity to, via the second serving cell:
receive, from the UE, an uplink message on an uplink resource of the second serving cell.

27. The network entity of claim 24, wherein the one or more processors are individually or collectively further operable to execute the code to cause the network entity to, via the second serving cell:
transmit, to the UE, a downlink message on a downlink resource of the second serving cell.

28. A method for wireless communication by user equipment (UE), comprising:
receiving, from a first serving cell, a broadcast system information message, wherein the broadcast system information message comprises system information for connecting to a second serving cell, and wherein the broadcast system information message comprises a synchronization signal block message, a system information block message, or any combination thereof;
transmitting, to the first serving cell based at least in part on receiving the broadcast system information message, a RACH preamble message associated with the second serving cell;
receiving, based at least in part on transmitting the RACH preamble message, a random access response message that indicates an uplink resource; and
transmitting, in response to receiving the random access response message, an uplink message on the uplink resource.

29. The method of claim 28, wherein the system information for connecting to the second serving cell comprises one or more random access channel sequences for transmitting a random access channel message, resources associated with random access channel occasions, one or more random access response search space configurations, a quantity of resource occasions in frequency, one or more second serving cell identifiers, or any combination thereof.

30. The method of claim 28, wherein the uplink resource is an uplink resource of the first serving cell, the method further comprising:
receiving, based at least in part on transmitting the uplink message, a downlink message on a downlink resource, wherein the downlink resource is a downlink resource of the first serving cell or a downlink resource of the second serving cell.
